(19) United States
(12) Patent Application Publication
(10) Pub. No.: US 2026/0189421 A1
(43) Pub. Date: Jul. 2, 2026

(54) METHODS AND SYSTEMS FOR GENERATING ACTION(S) FROM A MULTI-PARTY CONVERSATION

(71) Applicant: SAMSUNG ELECTRONICS CO., LTD., Suwon-si (KR)

(72) Inventors: Ranjan Kumar SAMAL, Bengaluru (IN); Kiranmayi GANDIKOTA, Bengaluru (IN); Gurpreet KAUR, Bengaluru (IN); Praveen Kumar GUVVAKALLU SIVAMOORTHY, Bengaluru (IN); Gopal Kumar AGRAWAL, Bengaluru (IN); Maithili JOSALKAR, Bengaluru (IN); Manasa SREEKESH, Bengaluru (IN)

(73) Assignee: SAMSUNG ELECTRONICS CO., LTD., Suwon-si (KR)

(21) Appl. No.: 19/545,452

(22) Filed: Feb. 20, 2026

Related U.S. Application Data
(63) Continuation of application No. PCT/KR2024/012276, filed on Aug. 19, 2024.

(30) Foreign Application Priority Data
Aug. 22, 2023 (IN) 202341056319
Aug. 9, 2024 (IN) 202341056319

(51) Int. Cl. H04L 12/18; G06N 5/04

(52) U.S. Cl. CPC H04L 12/1822; G06N 5/04; H04L 12/1831

(57) ABSTRACT

A method for recommending at least one user action to be executed in a multi-party conversation includes generating intent information of a participant based on the multi-party conversation, generating an inference for the participant based on the intent information; obtaining an action linked to the intent information based on the inference; and activating an application of an electronic device to perform at least one similar action determined for the participant based on the action linked to the intent information.

### CROSS-REFERENCE TO RELATED APPLICATION

This application is a bypass continuation application of International Application No. PCT/KR2024/012276, filed on Aug. 19, 2024, which is based on and claims priority under 35 U.S.C. § 119 to Indian Patent Non-Provisional Patent Application No. 202341056319, filed on Aug. 9, 2024, and Indian Provisional Patent Application No. 202341056319, filed on Aug. 22, 2023, the disclosures of which are incorporated herein by reference in their entireties.

### BACKGROUND

### 1. Field

The disclosure relates to methods and systems for managing actions in an Internet of Things (IoT) environment, and more particularly but not exclusively to methods and systems for recommending one or more actions from a multi-party conversation in the IoT environment

### 2. Description of Related Art

In general, when more than one participant is having a human-to human conversation (such as, physical conversation, online conversation, voice based conversation, text based conversation, etc.) in an IoT environment through respective IoT devices, some participants can decide to perform one or more activities (such as taking a call, a routine activity, reminder(s), event(s), schedule(s), and so on). Further, some participants can decide to not perform the one or more activities. Since, the discussion is typically an oral discussion, a participant may not recall what was discussed during the discussion, which may lead to one or more activities not being performed, among the discussed activities for the participant.

In a human-to-human conversation, often actions discussed are dependent on each other. However, related art solutions implemented in an IoT environment generate actions which do not take such dependencies into account. Therefore, a significant amount of user intervention is needed in making manual adjustment(s).

In the human-to-human conversation, often actions proposed will either lead to agreement, or disagreement, or neutral state. In related art solutions, actions are generated, which have no notion of agreements. Instead of presenting what is agreed, current solutions implemented in an IoT environment present all possible combinations.

Further, in the human to human conversation, different users will have different actions which are agreed upon. However, current solutions implemented in an IoT environment generate actions which do not take into account for action ownership among the participants.

Hence, there is a need in the art for solutions which will overcome the above mentioned drawback(s), among others.

### SUMMARY

One or more aspects of the disclosure provide methods and systems for generating one or more user action(s) to be executed from a multi-party conversation in an Internet of Things (IoT) environment.

One or more aspects of the disclosure provide methods and systems for generating a user oriented conversation graph with multi-level bi-party inferences which links users with crucial information target for one or more possible actions.

One or more aspects of the disclosure provide methods and systems for determining one or more candidate action(s) from the current and past conversations, and linking them to one or more bi-party multi-level inferences.

One or more aspects of the disclosure provide methods and systems for understanding an agreement of action between bi-parties in a user oriented conversation graph, and enabling the corresponding action and dependencies between the actions.

One or more aspects of the disclosure provide methods and systems for activating an action for all the users based on an inherent agreement of the action between bi-parties in a user-oriented conversation graph.

One or more aspects of the disclosure provide methods and systems for managing one or more user actions as generated from a multi-party conversation based on inherent agreement between a plurality of users in the multi-party conversation.

According to an aspect of the disclosure, there is provided a method for recommending at least one user action to be executed in a multi-party conversation, the method including: generating intent information including an intent of at least one of a first participant and a second participant, among a plurality of participants, based on the multi-party conversation; generating at least one first inference for the at least one of the first participant and the second participant based on the intent information; obtaining at least one first action linked to the intent information based on the at least one first inference; and activating an application of an electronic device to perform at least one similar action determined for the at least one of the first participant and the second participant based on at least one agreement between the first participant and the second participant of the multi-party conversation corresponding to the at least one first action linked to the intent information.

According to another aspect of the disclosure, there is provided a method for generating a plurality of user actions in a multi-party conversation, the method including: generating, by an inference engine of an electronic device, a first inference including an information about a first action to be performed by a first participant in the multi-party conversation, based on the first participant having a conversation with a second participant in the multi-party conversation; generating, by the inference engine of the electronic device, a second inference including an information about a second action to be performed by the second participant based on the second participant having a conversation with a third participant in the multi-party conversation; and generating, by the inference engine of the electronic device, a third inference including an information about a third action to be performed by the first participant, based on the first participant having a conversation with the third participant, wherein the information about the third action to be performed is generated considering the first action and the second action.

According to another aspect of the disclosure, there is provided an electronic device including: memory storing one or more instructions, and at least one processor configured to execute the one or more instructions to: generate intent information including an intent of at least one of a first participant and a second participant, among the plurality of participants, based on the multi-party conversation; generate at least one first inference for the at least one of the first participant and the second participant based on the intent information; obtain at least one first action linked to the intent information based on the at least one first inference; and activate an application of the electronic device to perform at least one similar action determined for the at least one of the first participant and the second participant based on at least one agreement between the first participant and the second participant of the multi-party conversation corresponding to the at least one first action linked to the intent information.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustrative drawings. Embodiments herein are illustrated by way of examples in the accompanying drawings, and in which:

FIG. 1A is a block diagram illustrating components of an action recommender unit in a caller assistance device for recommending one or more user oriented actions in a multi-party conversation, according to embodiments of the disclosure;

FIG. 1B is a block diagram illustrating a system for recommending one or more user oriented actions in a multi-party conversation, according to embodiments of the disclosure.

FIG. 2 is a block diagram illustrating subcomponents of the components of the action recommender unit, according to embodiments of the disclosure;

FIG. 3 illustrates a method for managing at least one user action to be executed in a multi-party conversation in an IoT environment, according to embodiments of the disclosure;

FIGS. 4A-4D illustrates an example scenario, in which, two users are exchanging information in a phone call, according to embodiments of the disclosure;

FIGS. 5A and 5B illustrates an example scenario, in which, multiple users are exchanging information in an IoT environment, according to embodiments of the disclosure; and

FIG. 6 illustrates a process of performing post identification of agreements between parties of the multi-party conversation, according to embodiments of the disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments. Further, in the present disclosure the terms “user”, and “participants” are used interchangeably. Furthermore, in the present disclosure the terms “user device”, and caller assistance device” are used interchangeably.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the operations required for understanding of aspects of the embodiments of the disclosure. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which include the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

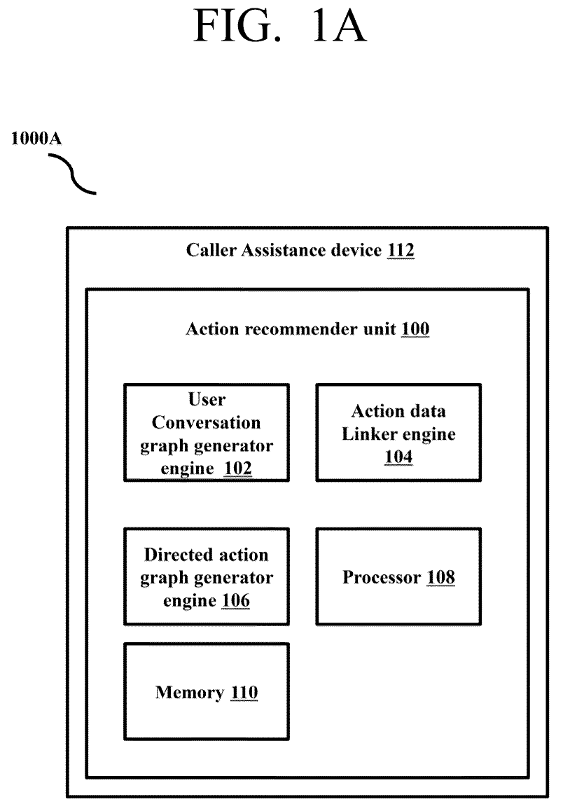

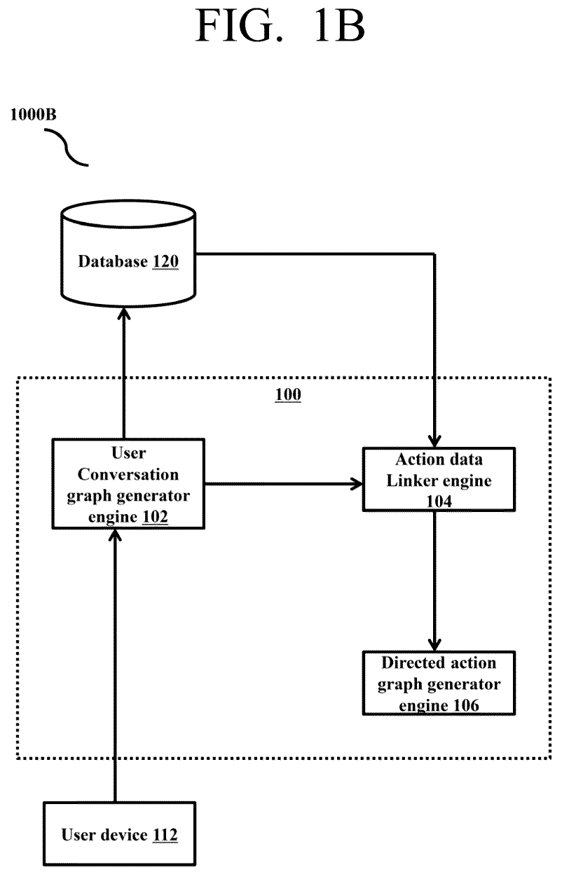

The embodiments herein achieve methods and systems for generating action(s) from a multi-party conversation in an Internet of Things (IoT) environment. Referring now to the drawings, and more particularly to FIGS. 1A through 7G, where similar reference characters denote corresponding features consistently throughout the figures, there are shown at least one embodiment.

FIG. 1A is a block diagram illustrating components of an action recommender unit (100) for recommending one or more user oriented actions in a multi-party conversation, according to embodiments of the disclosure. In an embodiment, the action recommender unit (100) can be integrated with a user device (112). The user device (112) can be used for calling assistance. Embodiments herein may use the terms “user device” and “caller assistance device” interchangeably. The action recommender unit (100) may include a user conversation graph generator engine (102), an action data linker engine (104), a directed action graph generator engine (106), a processor (108), a memory (110), and a communication module. However, the disclosure is not limited thereto, and as such, the action recommender unit (100) may include on or more other components, or one or more components may be combined.

In an embodiment, the user conversation graph generator engine (102) may generate at least a conversation information graph in a bi-party manner from the multi-party conversation of a plurality of participants. In an example embodiment, in the multi-party conversation, the plurality of participants converse for identifying a plurality of actions for said plurality of participants. The plurality of actions may include, but is not limited to, setting up a meeting, setting up a voice call, setting up a table reservation for meeting in a hotel, etc. A human conversation can be provided as input to the user conversation graph generator engine (102). The input can be one of a voice, a transcript, a text, a video, and so on. In an example embodiment, the user conversation graph generator engine (102) may generate a plurality of transcripts of the conversation. The user conversation graph generator engine (102) may use the plurality of transcripts to generate the conversation information graph for the multi-party conversation. In an embodiment, the conversation information graph for the plurality participants may include one or more bi-party conversation information. In an example embodiment, the one or more bi-party conversation information may be generated for at least a first participant and at least a second participant that are participating in the multi-party conversation. Further, the conversation graph generator engine (102) can generate one or more inferences from the multi-party conversation. In an embodiment, the one or more inferences are generated from the one or more bi-party conversation information of the conversation information graph. According to an embodiment, the conversation graph generator engine (102) may generate one or more multi-level inferences from the one or more inferences as generated from the one or more bi-party conversation information. The conversation graph generator engine (102) may be referred to as an inference engine.

In an embodiment, the action data linker engine (104) may determine and generate one or more first actions linked with corresponding one or more generated inferences, with respect to each participant of the multi-party conversation. In an embodiment, the action data linker engine (104) may correlate the one or more first actions with the corresponding generated one or more inferences.

In an embodiment, the directed action graph generator engine (106) may determine at least one inherent agreement for at least one first action, between the plurality of participants of the multi-party conversation and identify at least one similar action based on the determined at least one inherent agreement. In an embodiment, based on the determined at least one inherent agreement, the directed action graph generator engine (106) may activate the at least one similar action from the one or more first actions. According to an embodiment, the inherent agreement may include, but is not limited to, an agreed agreement, a disagreed agreement, and a neutral agreement. Further, in an embodiment, the directed action graph generator engine (106) may activate the at least one similar action from the one or more first actions. The at least one similar action for the plurality of participants can be the at least one first action among the one or more first actions to which each of the plurality of participants have agreed. Further, in an embodiment, the directed action graph generator engine (106) may determine dependency between the one or more first actions in order to identify the at least one similar action to be activated. In an embodiment, the user device (112) may include one or more user application modules linked with the action recommender unit (100) for enabling the at least one similar action to be executed.

The processor (108) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (108) may include multiple cores and is configured to execute the instructions stored in the memory (110). In an embodiment, the processor may control operation of the conversation graph generator engine (102), the action data linker engine (104), and the directed action graph generator engine (106). The processor (108) may be implemented by analog and/or digital circuits such as logic gates, integrated circuits, microprocessors, microcontrollers, memory circuits, passive electronic components, active electronic components, optical components, hardwired circuits and the like, and may optionally be driven by firmware. Further, the processor (108) is configured to execute instructions stored in the memory (110) and to perform various processes. The communication module is configured for communicating internally between internal hardware components and with external devices via one or more networks.

The memory (110) may store past conversation context between the plurality of participants of the multi-party conversation. In an embodiment, the past conversation context may include the conversation information graph, the one or more generated inferences, the one or more determined first actions, the identified at least one similar action, the one or more determined dependent actions and so on, for the plurality of participants. The memory (110) may also store instructions to be executed by the processor (108). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, in some examples the memory (110) can be considered a non-transitory storage medium. The term “non-transitory” may indicate that the storage medium is not embodied in a carrier wave or a propagated signal. However, the term “non-transitory” should not be interpreted that the memory (110) is non-movable. In certain examples, a non-transitory storage medium may store data that can, over time, change (e.g., in Random Access Memory (RAM) or cache).

According to an embodiment, the action recommender unit (100) may further include the communication module. The communication module may include an electronic circuit specific to a standard that enables wired or wireless communication. The communication module is configured to communicate internally between internal hardware components of the action recommender unit (100) and with external one or more user devices via one or more networks. In an example embodiment, the one or more networks for accomplishing communication between a plurality of user devices can be one or more wireless networks, for example, but not limited to one or more fourth generation (4G) network, one or more fifth generation (5G) network, one or more 6G network, one or more Open Radio Access Network (ORAN) or the like. The user device (112) is a caller assistance device. In an example embodiment, the caller assistance device (112) may include, without limitation, a laptop, a smart phone, a desktop computer, a notebook, a Device-to-Device (D2D) device, a vehicle to everything (V2X) device, a foldable phone, a smart TV, a tablet, an immersive device, an internet of things (IoT) device and so on.

FIG. 1B is a block diagram illustrating a system including components of the action recommender unit (100), a database (120) and at least one user device (112), according to embodiments of the disclosure. In an embodiment, the action recommender unit (100) may be located in a remote cloud based environment. A plurality of user devices related to a plurality of participants of a multi-party conversation, may communication with the action recommender unit (100) via a communication module of the plurality of user devices. In an example embodiment, the communication module may include one or more wired and wireless communication networks. Referring to FIG. 1B, the action recommender unit (100) may receive device capability information from the user device (112) of a participant of the multi-party conversation. The action recommender unit (100) may use the received device capability information to identify the user device that can be suitable for, generating one or more first actions and activating/performing one or more similar actions tailored for the user device (112). In an embodiment, a user conversation graph generator engine (102) may generate a multi-party human to human conversation transcript for generating one or more conversation information for a plurality of participants, from the conversation transcript. For example, the user conversation graph generator engine (102) or the action recommender unit (100) may include a voice or speech recognition model or natural language processing model configured to convert a conversation between the participants into conversation transcript. Further in an embodiment, the user conversation graph generator engine (102) may generate the one or more conversation information of the plurality of participants of the multi-party conversation in a bi-party manner. In an example embodiment, the bi-party manner of conversation information generation may include generation of information from conversation transcript of every two participants (e.g., a pair of participants) of the plurality of participants. Further, the conversation graph generator engine (102) may generate one or more inferences from the conversation information of the plurality of participants. In an embodiment, the action recommender unit (100) may store the one or more conservation information of the plurality of participants in the database (120) located in the cloud based environment. The action recommender unit (100) may communicate with the database via a communication module of the action recommender unit (100). The communication module may be a wired and/or a wireless communication module. The database (120) may receive the one or more conversation information, and the one or more inferences corresponding to the one or more conversation information from the user conversation graph generator engine (102). The action data linker engine (104) may receive an output from the user conversation graph generator engine (102). In an embodiment, the output from the user conversation graph generator engine (102) may include the one or more conversation information generated by the conversation graph generator engine (102) from the multi-party conversation. Based on the output, the action data linker engine (104) may determine one or more first actions for the plurality of participants. In an embodiment, the action data linker engine (104) may receive, from the database (120), past conversation context of participants participated in the multi-party conversation. For example, the past conversation context of participants participated in the multi-party conversation may be used by the action data linker engine (104) to determine the one or more first actions for the plurality of participants. Further, in an embodiment, the action data linker engine (104) may determine the one or more first actions for the plurality of participants upon correlating with the one or more inferences, and the one or more conversation information. Further, the output from the action data linker engine (104) may be received by the directed action graph generator engine (106). In an embodiment, the directed action graph generator engine (106) may estimate an inherent agreement between the plurality of participants, for the one or more first actions. Further, the directed action graph generator engine (106) may activate at least one similar action from the one or more first actions, based on the inherent agreement between the plurality of participants. In an example embodiment, the at least one similar action is at least one first action from the one or more first actions for which at least two participants of the plurality of participants have agreed. In an example embodiment, the directed action graph generator engine (106) may activate, the at least one similar action by translating the similar action to at least one targeted application/device for execution. In an embodiment, the user device (112) may include a plurality of user application modules linked with the action recommender unit (100) for enabling activation of the at least one similar action, which is to be executed.

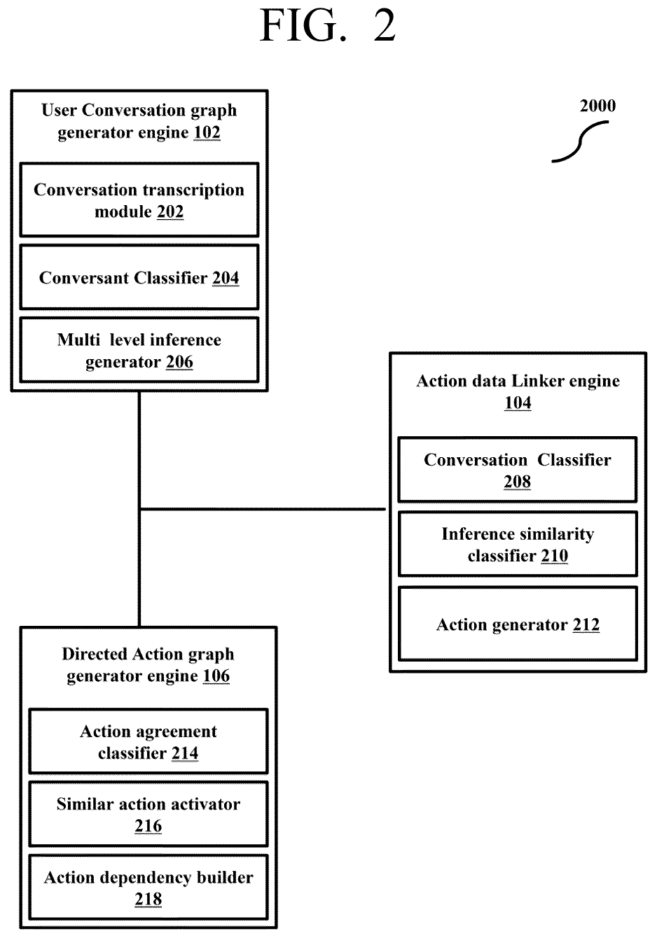

FIG. 2 is a block diagram illustrating subcomponents of the components of the action recommender unit (100), according to embodiments of the disclosure. In an embodiment, the action recommender unit (100) can be associated with a host server located in a cloud-based environment and connected to a user device via a communication module. Further, in an embodiment, the action recommender unit (100) can be integrated with the user device.

In an embodiment, the user conversation graph generator engine (102) may include a conversation transcription module (202), a conversant classifier (204), and a multi-level inference generator (206). The conversation transcription module (202) may be configured to generate a plurality of conversation transcripts for a plurality of participants of a multi-party conversation. The conversant classifier (204) may identify and distinguish the plurality of participants of the multi-party conversation. In an example embodiment, the conversant classifier (204) may identify the plurality of participants from a plurality of device IDs corresponding to the plurality of user devices. Further, in an embodiment, the conversant classifier (204) may receive the device capabilities for the plurality of user devices. The multi-level inference generator (206) may analyze the plurality of conversation transcripts and generate a conversation information graph for the plurality of participants based on the plurality of device capabilities. In an embodiment, the conversation information graph may include conversation information of the plurality of participants. The conversation information can be organized in a bi-party manner (e.g., conversation information related to conversation between two parties). In an embodiment, the conversation information graph for the plurality of participants includes one or more user intents for each of the plurality of participants. The conversation information graph links a participant to other participants via the one or more user intents. The one or more user intents may include information exchange for an action to be executed, previous actions executed, and so on. In an example embodiment, the conversation information graph includes at least one first inference (inference level1) of the multi-party conversation, between a first participant and a second participant. Further, the conversation information graph includes at least one second inference (inference level2) from the multi-party conversation, between the first participant and a third participant. Furthermore, the conversation information graph includes the at least one second inference (inference level2) from the multi-party conversation between the second participant and the third participant. Similarly, multiple levels of inferences are generated from the multi-party conversation between two participants. In an embodiment, the multi-level inference generator can generate at least one multi-level inference from the generated levels of inferences of the multi-party conversation. One or more inferences as generated by the multi-level inference generator (206) can include one or more action information for the plurality of participants. In an embodiment, output of the user conversation graph generator (102) may be received by the action data linker engine (104).

In an embodiment, the action data linker engine (104) may include a conversation classifier (208), an inference similarity identifier (210), and an action generator (212). The conversation classifier (208) may identify and classify at least one conversation information of the multi-party conversation into several types of conversation. The types of conversation may include, without limitation, an action type conversation, a query type conversation, a response type conversation, and so on. In an example embodiment, the conversation classifier (208) may estimate a conversation to be at least one of an action, a query and a response, which can be used to classify the conversation into several types of conversation. In an embodiment, the conversation classifier may further classify the action type conversation into a form of the action type such as, without limitation, an execute type action, a response type action, and so on. In an embodiment, the inference similarity identifier (210) may identify one or more similar inferences having similar intents.

The action generator engine (212) may generate one or more linked actions (for example, a first action as describes above) for the plurality of participants, based on the one or more similar inferences having similar intents. For example, the one or more linked actions are consequently linked with the multi-level inference outputs related to a conversation chain of the multi-party conversation, which can be used to establish similarity between inferences and actions. Further, in an embodiment, the action generator engine (212) may receive one or more similar inferences corresponding to one or more past conversation context from the database, in order to generate the one or more linked actions. In an embodiment, the action generator (212) may generate multiple linked actions from a single conversation of the multi-party conversation. The output of the action data linker engine (104) can be received by the directed action graph generator engine (106).

In an embodiment, the directed action graph generator engine (106) may include an action agreement classifier (214), a similar action activator (216) and action dependency builder (218). The action agreement classifier (214) may receive an input from the user conversation graph generator engine (102) and the action data linker engine (104). The input may include the one or more linked actions corresponding to the one or more similar inferences for current conversation utterance, conversation information of one or more previous N conversation utterances, and conversation information of one or more following N conversation utterances, with respect to the plurality of participants. The action agreement classifier (214) can determine at least one inherent agreement for the one or more linked actions between the plurality of participants based on the received input from the user conversation graph generator engine (102) and the action data linker engine (104). In an embodiment, the inherent agreement for the one or more linked actions can be one of an agreed agreement, a disagreed agreement, and a neutral agreement.

The similar action activator (216) may activate at least one similar action from the one or more linked actions based on the determined inherent agreement between the plurality of participants. In an embodiment, the similar action activator (216) may activate the at least one similar action for which the plurality of participants have agreed. The similar action activator (216) may translate information for the at least one similar action to at least one target application information to perform a further process such as, but not limited to, activation of the similar action. The action dependency builder (218) may determine at least one dependent action from the one or more similar actions. The one or more similar actions correspond to the inherent agreement between the plurality of participants. In an embodiment, the at least one dependent action can be used for identifying the at least one similar action to be activated.

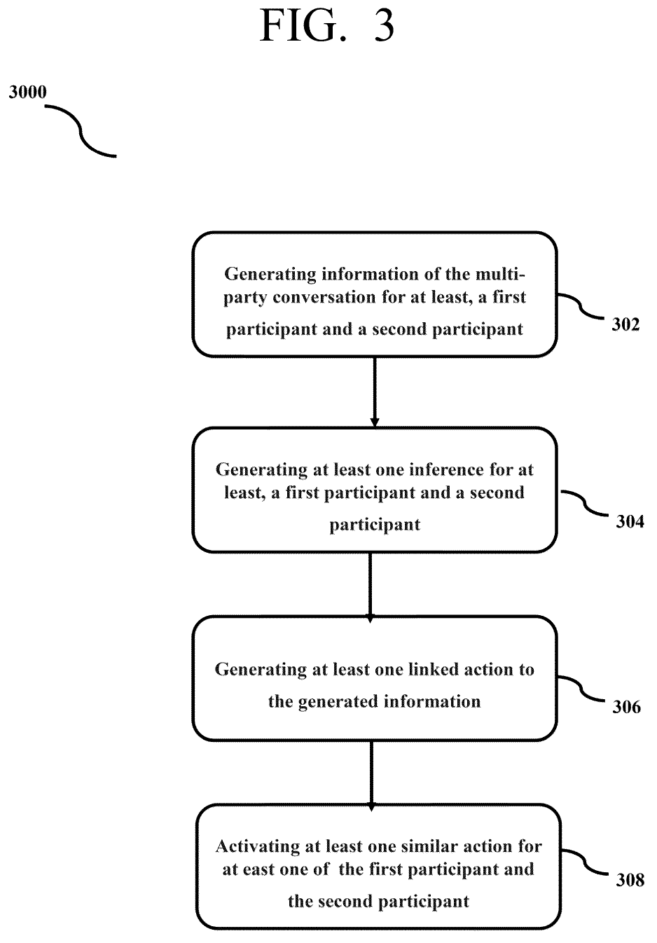

FIG. 3 illustrates a method (3000) for managing at least one user action to be executed in a multi-party conversation, according to embodiments of the disclosure. At operation 302, the method may include generating, by an action recommender engine (100), information for at least a first participant and a second participant of the multi-party conversation. For example, the multi-party conversation may include two or more participants. The generated information may include an intent of at least one of the first participant and the second participant. In an embodiment, generating the information of the multi-party conversation for at least the first participant and the second participant, may include identifying a plurality of text entities from at least one conversation transcript of the multi-party conversation. In an example embodiment, text entities may include conversation type, domain, place name, participant name, time, date, action type, and so on. The plurality of text entities are extracted from the intent. The action recommender engine (100) may identify the first participant and the second participant from corresponding device capabilities. In an embodiment, at least one of the first participant and the second participant may be having a conversation with a third participant in the multi-party conversation. The method may further include generating, by the action recommender unit (100), conversation information for the third participant.

At operation 304, the method may include, generating, by the action recommender unit (100), at least one inference for at least one of the first participant and the second participant. The at least one inference (inference level1) includes information on at least one linked action for the at least one of the first participant and the second participant. Further, the method may include generating, by the action recommender unit (100), at least one inference (inference level2) for at least one of the first participant having a conversation with a third participant. Further, the method may include generating, by the action recommender unit (100), at least one inference (inference level3) for at least one of the second participant having conversation with the third participant. In an embodiment, the action recommender unit (100) can generate at least one multi-level inference from the inference levels.

At operation 306, the method may include generating, by the action recommender unit (100), at least one linked action to the generated information, for at least one of the first participant and the second participant. In an embodiment, the at least one linked action correlates with the at least one inference generated from the conversation information of the first participant and the second participant. Further, in an embodiment, the at least one linked action correlates with the at least one inference generated from the conversation information of the first participant and the third participant. Furthermore, in an embodiment, the at least one linked action correlates with the at least one inference generated from the conversation information of the second participant and the third participant. Further, in an embodiment, the generated at least one linked action correlates with the multi-level inference. The at least one linked action for at least one of the first participant and the second participant can be generated by the action recommender unit (100) from past conversation information of participants of the multi-party conversation.

At operation 308, the method may include, activating, by the action recommender unit (100), at least one similar action for at least one of the first participant and the second participant. In an embodiment, the action recommender unit can estimate, an inherent agreement for the at least one linked-action between the first participant and the second participant, from the multi-party conversation. The at least one similar action is identified as the at least one linked action for which the first participant and the second participant have agreed. Further, the at least one similar action can be identified upon determining by the action recommender unit (100) dependency of the at least one linked action to another linked action generated from the multi-party conversation.

The operations of the method 3000 illustrated in FIG. 3 may be performed in the order presented, in a different order or simultaneously. Further, in some embodiments, some actions listed in FIG. 3 may be omitted.

One or more embodiments of the disclosure are further exemplified by the following examples. However, the examples are provided merely for better understanding using some example applications and are not limiting, and as such, embodiments of the disclosure can be implemented in diverse fields of application.

### Example 1: Exchanging Information Over a Phone Call: User Conversation Graph Generator Engine

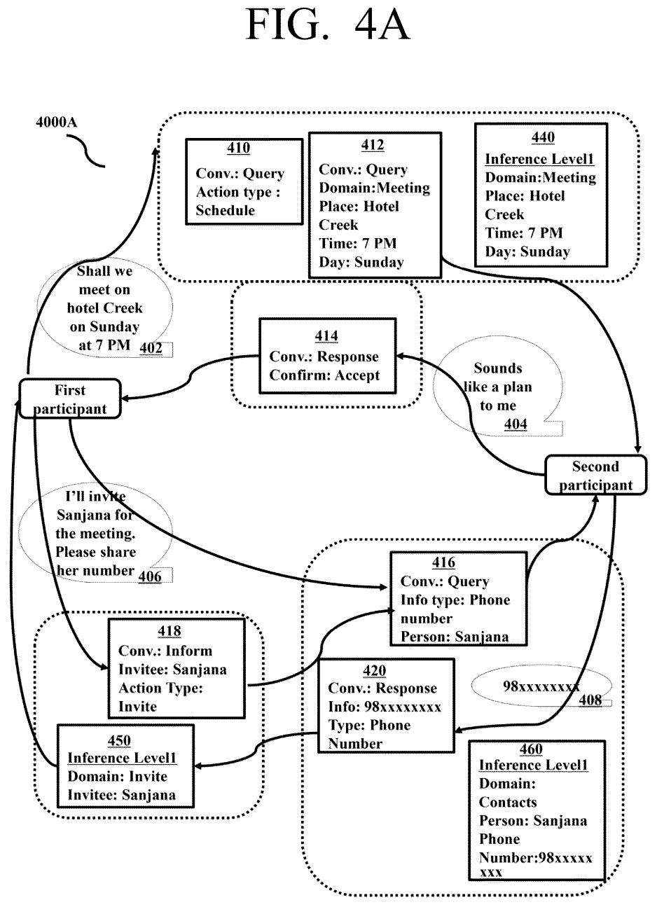

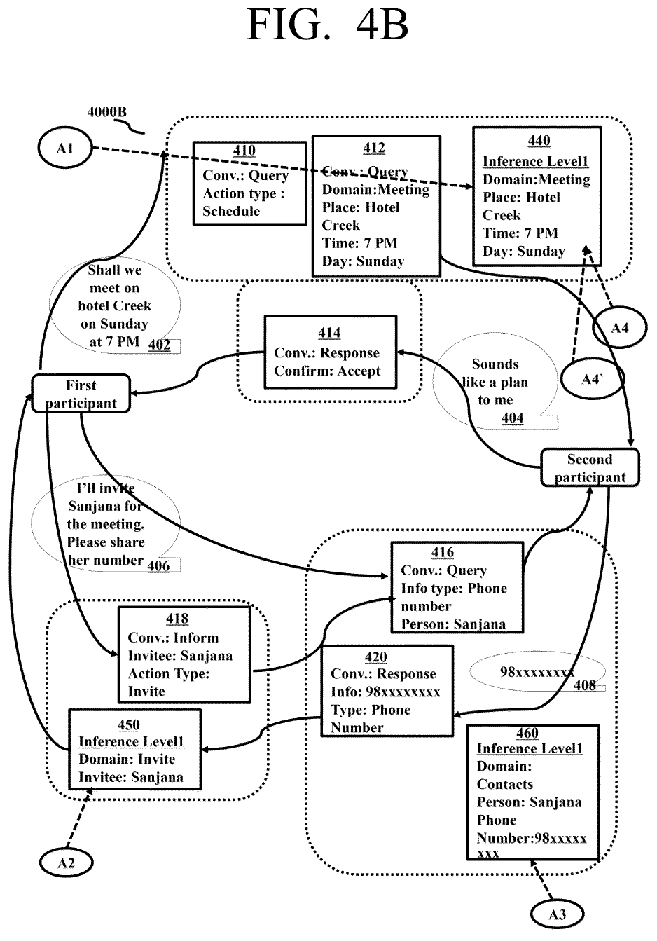

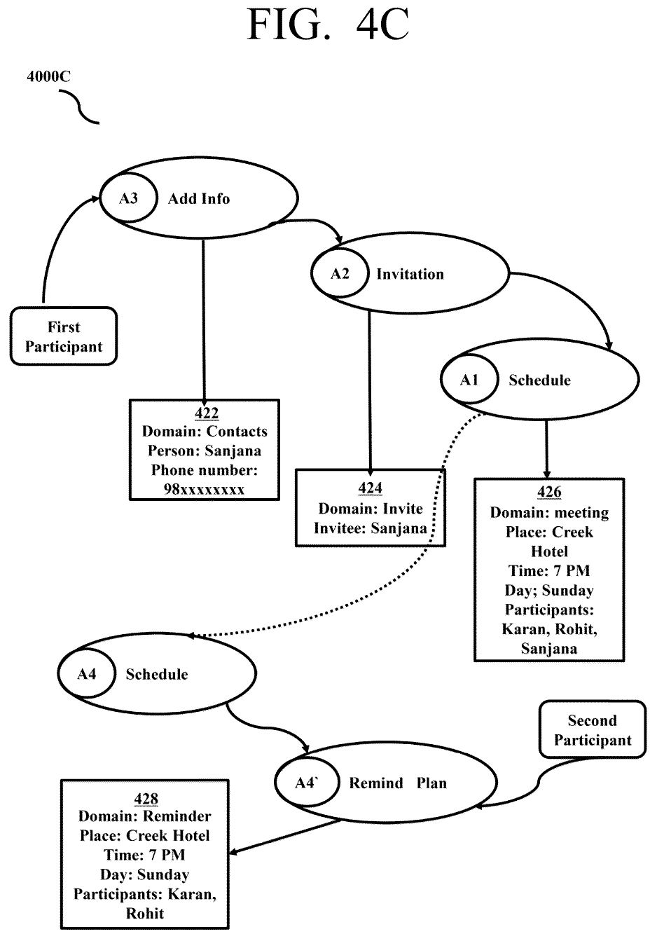

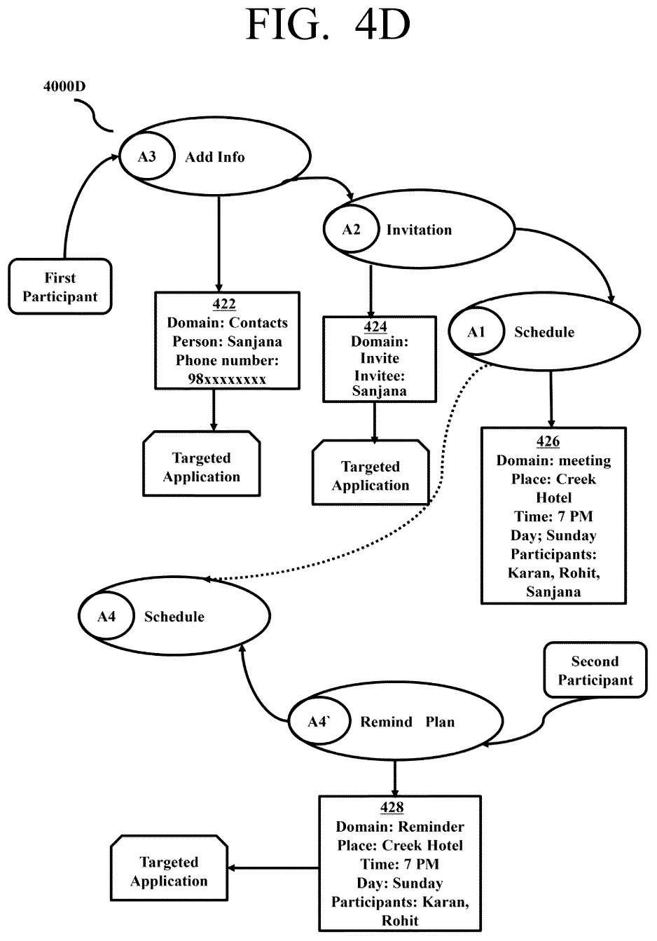

FIG. 4A illustrates a flow diagram of a multi-party conversation between two participants. The multi-party conversation includes exchange of information over a phone call. A first participant (Karan) and a second participant (Rohit) have joined in the phone call conversation via a user device.

In a first utterance (402) of the multi-party conversation, over the phone call, Karan asks Rohit for a meeting at Creek Hotel on Sunday at 7 PM. A user conversation graph generator engine (102) of a user device (112) generates, from a conversation transcript of the phone call from Karan to Rohit, a multi-party conversation information graph in a bi-party manner. The generated multi-party conversation information graph includes conversation information (410, 412) may include, a plurality of text entities obtained from the conversation transcript. The obtained plurality of text entities correlates with the intent of Karan. The plurality of text entities includes a conversation type of the intent: query, an action type of the intent: schedule, a domain of an action: meeting, place: Creek Hotel, day: Sunday, and time: 7 PM.

Next, in a second utterance (404) of the multi-party conversation, the second participant (Rohit) responds to the phone call from Karan, accepts the meeting and agrees to meet at said place in said day and at said time. The user conversation graph generator engine (102), generates conversation information (414) may include a plurality of text entities corresponding to response of Rohit to Karan. The generated plurality of text entities correlates with the intent of Rohit. The generated plurality of text entities may include a conversation type: response, and a confirmation type: accept. The user conversation graph generator engine (102) further generates a corresponding inference (inference level1) (440) from the conversation information. The inference (440) may include information, such as the domain of action: meeting, place: Creek Hotel, day: Sunday, and time: 7 PM.

Further, in a third utterance (406) of the multi-party conversation, Karan informs Rohit in the phone call, that he will invite a third participant (Sanjana) for the meet, and requests Rohit to share her number. The user conversation graph generator engine (102) generates conversation information (416) corresponding to intent of Karan in the multi-party conversation graph. The conversation information (416) may include, a conversation type: Query, an information type: Phone number, and a person name: Sanjana. Further, the conversation information (418) may include a conversation type: inform, an invitee name: Sanjana, and an action type: Invite. The user conversation graph generator engine (102) generates an inference (inference level1) (450) from the conversation information (418). The inference (450) may include, a domain: Invite, and an invitee: Sanjana.

In a fourth utterance (408) of the multi-party conversation, in response to Karan's query, Rohit shares Sanjana's phone number over the phone call. The user conversation graph generator engine (102) generates conversation information corresponding to the intent of Rohit, in the multi-party conversation graph. The conversation information (420) may include, a conversation type: response, an Information: 98xxxxxxxx, and a type of information: phone number. Further, the conversation graph generator generates an inference (inference level1) (460) corresponding to the conversation information (420, 416). The inference may include, a domain: contacts, a person name: Sanjana, and phone number: 98xxxxxxxx.

### Example 2: Exchanging Information Over a Phone Call: Action Data Linker Engine

FIG. 4B illustrates a flow diagram of a multi-party conversation between two participants. The multi-party conversation includes exchange of information over a phone call. The first participant (Karan) and the second participant (Rohit) have joined in the phone call via the user device (112). One or more actions corresponding to the multi-party conversation are generated by an action data linker engine (104). The action data linker engine (104) understands conversation between Rohit and Karan and generates a sequence of linked actions. The action data linker engine (104) classifies conversation information of the multi-party conversation into an action type conversation, a query type conversation, and a response type conversation. Further, the action data linker engine (104) estimates if an utterance in a conversation can be an action, if an utterance in a conversation can be a query and if an utterance in a conversation can be a response. The action data linker engine (104) further classifies the action type conversation into a form of action such as an execute type action, and a response type action. The action data linker engine (104) generates one or more linked actions for the participants of the multi-party conversation, based on one or more similar inferences having similar intents. The action data linker engine generates one or more linked actions for Karan. The one or more linked actions (A1, A2, A3) may include scheduling the meeting (A1) linked to the inference level1 (440), adding information (A3) (phone number) linked to the inference level1 (460) and inviting Sanjana (A2) linked to the inference level1 (450). Further, the action data linker engine generates one or more linked actions for Rohit. The one or more linked actions may include scheduling the meeting (A4) and remind plan (A4′) linked to the inference level1 (440).

### Example 3: Exchanging Information Over a Phone Call: Action Graph Generator Engine

A directed action graph generator engine (106) of the action recommender unit (100) determines dependencies between the linked actions. Further, the directed action graph generator engine (106) determines an inherent agreement for the one or more linked actions between the participants. The directed action graph generator engine (106) determines the action dependency of A1 on A4 for confirmation on the query for meeting. Further, the directed action graph generator engine (106) determines action dependency of A1 on A2 and A3, for adding phone number of Sanjana and inviting her for the meeting. Furthermore, the directed action graph generator engine (106) determines action dependency of A4′ on A4 for reminding the plan once the meeting has been scheduled. The directed action graph generator engine (106) further activates the similar actions (A1, A2, A3 and A4) based on the inherent agreement between the first participant and the second participant.

FIG. 4C illustrates a flow diagram of all the one or more linked actions corresponding to the participants of the multi-party conversation in a determined sequence. For each of the action, action information is aggregated from Inference Level information.

A sequence of the linked actions generated for Karan, from the multi-party conversation between the first participant (Karan) and the second participant (Rohit) are as follows:
Adding information of Sanjana (A3). Corresponding action information (422) may include: a domain of action: Contact, person name: Sanjana, and Phone number: 98xxxxxxxx
Inviting Sanjana. Corresponding action information (424) may include: a domain of action: Invite, Invitee: Sanjana.
Scheduling the meeting. Corresponding action information (426) may include:
a domain of action: meeting, Place: Creek Hotel, Time: 7 P, Day: Sunday, Participants: Karan, Rohit, Sanjana.

A sequence of the linked actions generated for Karan, from the multi-party conversation between the first participant (Karan) and the second participant (Rohit) are as follows:
Scheduling the meeting (A4).
Reminding the plan (A4′). Corresponding action information (428) may include: a domain of action: Reminder, Place: Creek Hotel, Time: 7 PM, Day: Sunday, Participants: Karan, Rohit.

FIG. 4D illustrates a flow diagram of all the one or more linked actions corresponding to the participants of the multi-party conversation in a determined sequence. Each of the linked actions having action information are associated with corresponding one or more target applications. The directed action graph generator engine (106) activates at least one linked action of the one or more linked actions to which the participants have agreed through the one or more target applications. The one or more target applications execute intents of participants of the multi-party conversation from the action information. The one or more target applications for the one or more linked actions are such as, a WhatsApp or calling App for the action information for calling or inviting Sanjana; a calendar for setting reminder for the meeting, and so on.

### Example 4: Exchanging Information Over a Phone Call: Nested Action and Context Delegation

In continuation to a prior conversation between Karan and Rohit, Karan reaches out to Sanjana via WhatsApp. Karan shares his plan to meet Sanjana along with Rohit. Sanjana agrees to the plan. Karan informs participation of Sanjana in the meeting to Rohit. One or more linked actions generated for Karan, Rohit and Sanjana form the multi-party conversation, based on device capabilities of their respective user devices. A generated action for Karan includes, dinner with Rohit and Sanjana at Creek Hotel on Sunday 7 PM. A corresponding calendar entry is made post the multi-party conversation for the generated action for Karan. Further, a generated action for Sanjana include dinner with Karan at Creek Hotel on Sunday 7 PM. A corresponding calendar entry is made post the multi-party conversation for the generated action for Sanjana. A generated action for Rohit is updated with new participant Sanjana. The generated action includes dinner with Karan, and Sanjana at Creek Hotel on Sunday 7 PM. A corresponding calendar entry is made.

Further, in an alternative scenario, Sanjana expresses her inability to meet Karan and Rohit due to her health condition. In this regard, the system automatically infers the action recommender unit (100) is recommending to meet at Sanjana's residence instead of Creek Hotel. Furthermore, in a scenario, Sanjana expresses her inability to meet Karan and Rohit due to her health condition and the action management system activates one or more similar actions for Karan and Rohit for meeting at Creek Hotel, while Sanjana is not attending.

FIGS. 4A-4D illustrate an example scenario, in which, two users are exchanging information in a phone call. The two users (Rohit and Karan) discuss meeting at an address. The two users (Rohit and Karan) also decide to invite Sanjana, and Rohit shares Sanjana's number with Karan. According to an embodiment, the action recommender unit (100) understands the conversation between Rohit and Karan and generates a sequence of actions. Further, embodiments herein illustrate the example generated actions. Embodiments herein further illustrate an example user conversation graph generator and an example action data linker. Further, the embodiments herein depicts an example action dependency generated by the direction action graph generation module. Furthermore, the embodiments herein depict an example action graph linked by the direction action graph generation module. The embodiments herein further depict an example application linking by the direction action graph generation module. In this example scenario, Karan gets in touch with a friend, Rohit. While Karan visits a town where Rohit is residing, he wanted to meet Rohit for dinner. They both discuss to invite Sanjana. In this regards, Rohit shares Sanjana's number with Karan. Embodiments herein generate multiple actions post call disconnection. In this manner, by providing the action (e.g., application or interface to call), Karan can easily and conveniently perform his action by just clicking on the actions instead of remembering all information.

### Example 5: Exchange of Information Between Multiple Participants of a Multi-Party Conversation

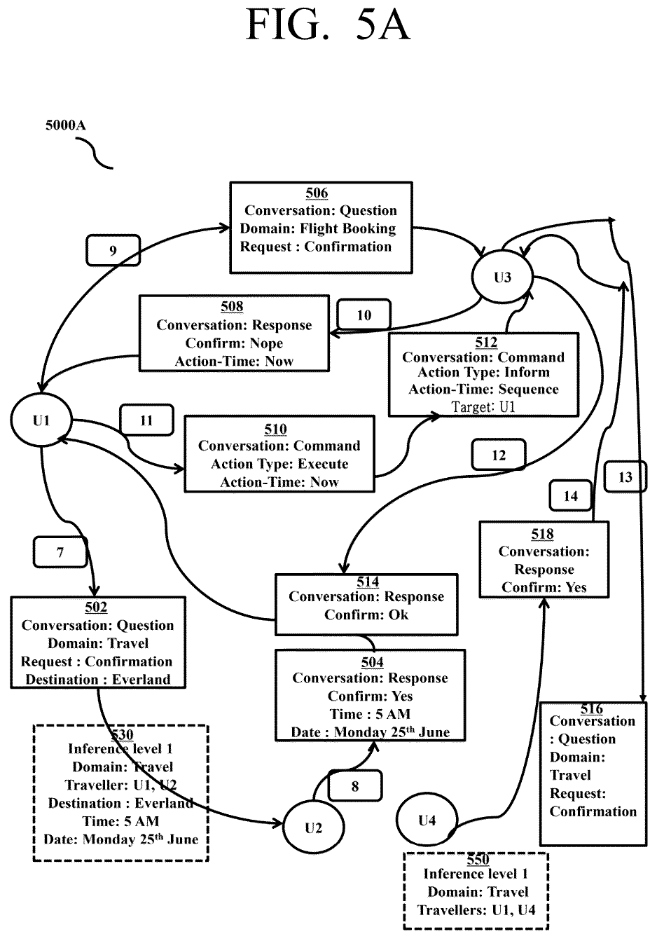

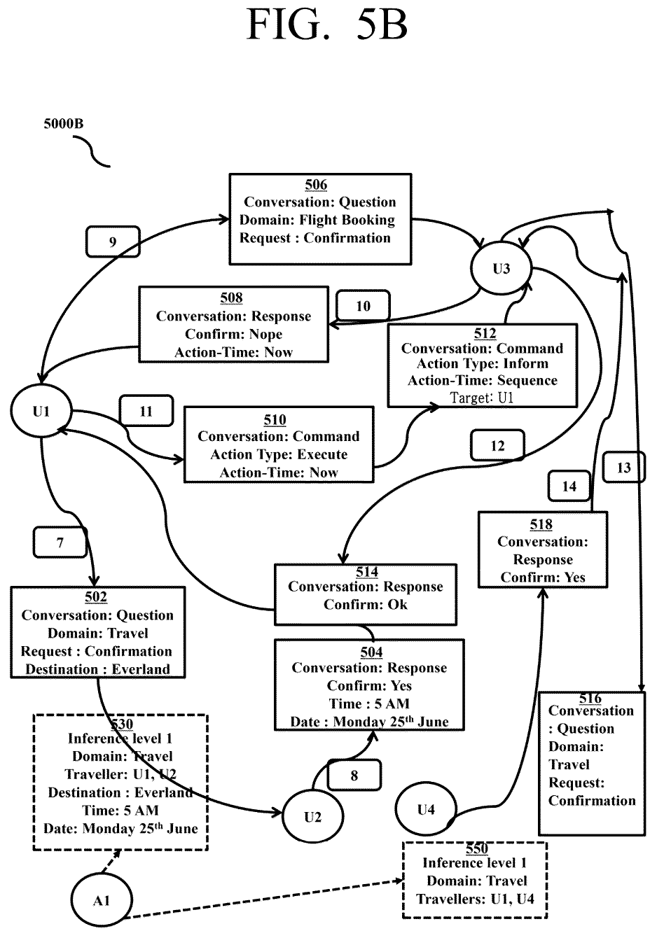

FIG. 5A illustrates a flow diagram of a multi-party conversation for four participants (U1, U2, U3, U4). The four participants use four user devices for conversing. A first participant (U1) inquires with a second participant for confirmation on joining a trip to Everland (7). The second participant confirms to the first participant about his joining the trip to Everland with date and time (8). Further the first participant asks a third participant about status of a flight booking for the trip to Everland (9). The third participant in response to the first participant replies that he was busy in other activities (10). The first participant responds to the third participant to book flight tickets immediately and confirm the same (11). Further, the third participant agrees to the statement of the first participant for immediate booking of flight tickets (12). The third participant further checks with a fourth participant if he is travelling from the same airport as the first participant (13). The fourth participant responded to the third participant that, he is travelling from the same airport (14). The action recommender unit (100) generates from a conversation graph the multi-party conversation. The conversation graph may include conversation information of the four participants, in a bi-party manner.

The action recommender unit (100) generates conversation information between the first participant and the second participant, from conversation no. 7. The conversation information (502) may include a conversation type: question, a domain of an action: travel, a request for confirmation, and a destination: Everland. Further, the action recommender unit (100) generates the conversation information (504) between the first participant and the second participant, from conversation no. 8. The conversation information includes a conversation type: response, confirmation, a time, and a date. Similarly, the action recommender unit (100) generates conversation information (506) between the first participant and the third participant, from conversation no. 9. The conversation information may include a conversation type; question, domain of an action: flight booking, and a request: confirmation. Further, the action recommender unit (100) generates conversation information (508) between the third participant and the first participant, from conversation no. 10. The conversation information may include a conversation type: response, confirmation: nope, and an action-time: now. The action recommender unit (100) further generates conversation information (510) between the first participant and the third participant, from conversation no. 11. The conversation information may include a conversation type: command, an action type: execute, and an action time: now. The action recommender unit (100) further generates conversation information (512) between the first participant and the third participant, from conversation no. 11. The conversation information may include a conversation type: command, an action type: execute, an action time: sequence, and a target: U1. Further, the action recommender unit (100) generates conversation information (514) between the third participant and the first participant, from conversation no. 12. The conversation information may include a conversation type: response, and a confirmation: OK. The action recommender unit (100) further generates conversation information (516) between the third participant and a fourth participant, from conversation no. 13. The conversation information may include a conversation type: response, a domain of action: travel, and a request: confirmation. Further, the action recommender unit (100) generates conversation information (518) between the fourth participant and the third participant, from conversation no. 14. The conversation information may include a conversation type: response, and a confirmation: yes.

An inference (inference level1) (530) can be generated from conversation Nos. 7 and 8 between the first participant and the second participant. The inference level1 (530) includes inference information. The inference information may include a domain of action: travel, traveler: U1 and U2, a destination: Everland, a time: 5 AM, and a date: Monday. Further, the action recommender unit (100) generates an inference (inference level1) (550) from conversation between U3 and U4. The inference level1 (550) includes inference information. The inference information may include a domain of action: travel, and traveler: U1 and U4.

The action recommender unit (100) generates one or more linked actions for the participants. As illustrated in FIG. 5B, the action recommender unit (100) generates a linked action (A1) corresponding to the inference level1 (530) obtained from conversation of U1 and U2 and the inference level1 (550) obtained from conversation of U3 and U4. The linked action (A1) includes action information. The action information may include a name of action: ticket booking, an action type: execute, an action time: Now, a domain: travel, traveler: U1, U2, U4, destination: Everland, time: 5 AM, and date: Monday, etc.

The action recommender unit can determine the linked action as a similar action to which all parties of the multi-party conversation have agreed. Based on the inherent agreement of U1, U2 and U4, the action recommender unit (100) activates one or more similar actions to be executed by U3 of the multi-party conversation.

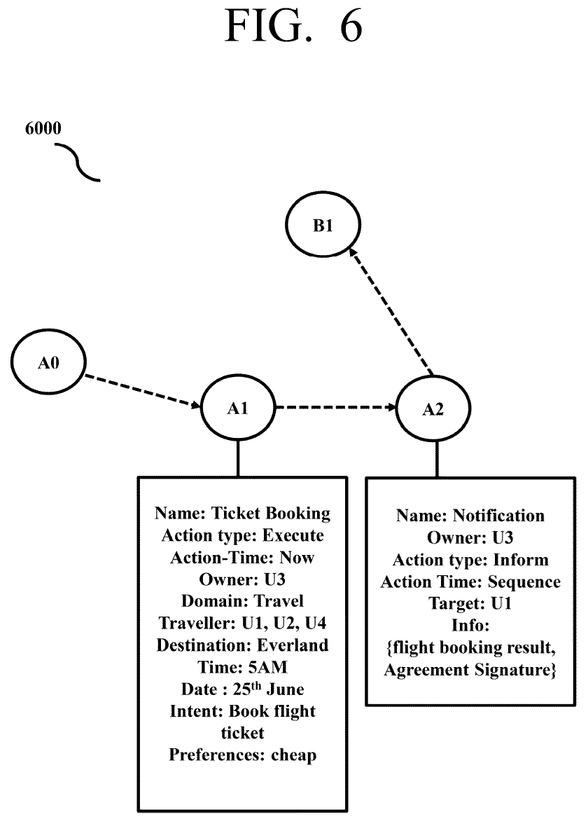

FIG. 6 illustrates a process of performing post identification of agreements between parties of the multi-party conversation in an IoT environment, according to embodiments of the disclosure. The process includes checking by the action recommender unit (100), one or more past actions with travelers U1, U2, and U4. The action recommender unit (100) receives action(s) related to U3 from another parallel conversation. The action recommender unit (100) can identify an aggregated action from current conversation and parallel conversation having the same intent and as agreed by the participants of the corresponding current conversation and another parallel conversation.

Embodiments herein disclose methods and systems for generating action(s) from a multi-party conversation. Embodiments herein disclose methods and systems for generating a user oriented conversation graph with multi-level bi-party inferences which links users with crucial information target for one or more possible actions. Embodiments herein disclose methods and systems for determining the candidate action(s) from the current and past conversations, and linking the determined candidate action(s) to one or more bi-party multi-level inferences. Embodiments herein disclose methods and systems for understanding the agreement of action between the bi-parties in the user conversation graph, and enabling the corresponding action and dependencies between the actions.

Embodiments herein can generate sequence actions based on dependencies and can generate one or more sequenced actions in a specific order to bring clarity to the user along with maximization of automation. The actions are dependent on each other as discussed in a human to human conversation.

Embodiments herein present actions based on agreement(s) between the participants of a conversation and can enable/disable action(s) based on agreements between the participants. Embodiments herein can disable agreed actions when there is a disagreement or neutral remark from one or more of the participants.

Embodiments herein can generate one or more user specific action(s). Embodiments herein can present actions, which can be linked with one or more of the participants. Different actions should be generated for different participants.

In an embodiment, a human conversation is provided as input. The input can be one of a voice, a transcript, a video, and so on. A user conversation graph generator generates bi-party data along with multi-level inferences. Different participants have different devices. Not all of them would be able to create actions. Hence the device capability information will enable the host device to generate actions tailored for the user's device. Further, past conversation details (from a past conversation content/datastore/database) can be used for generating the actions. The actions from the bi-party conversations are determined by an action data linker, and the actions are linked to related data across the bi-party conversation. Further, a directed action graph generation module estimates an agreement from the bi-party and linked bi-party conversations, for all the determined actions. Based on the agreement, the action and the dependent actions are activated. The generated action graph(s) are stored into the past conversation content/datastore/database for future use.

Embodiments herein analyze the multi-party conversation and generates information graph per conversation based on the device capabilities from different participants. Embodiments herein link the information with the user(s), which are organized in a bi-party fashion. Embodiments herein link the user to other users via topic, intent, previous actions, information exchange such as slots, etc.

Embodiments herein discloses the action data linker engine (104) which classifies the conversation utterances to be action/query/response. For an action type, the module generates action types such as execute/inform, etc. The action is linked with the multi-level inference outputs related to the conversation chain to establish similarity. The action data linker can generate multiple actions from a single conversation utterance.

Embodiments herein disclose directed action graph generation module which determines inherent agreement between the action assigner and assignee, and uses the inferred agreement to enable/disable the action. The directed action graph generation module establishes action dependencies by using the utterance, and the action information. Finally, the directed action graph generation module translates the action information to target application information for further processing.

The action recommender unit (100) can be used by multiple application (e.g., apps) which support multi-party conversation such as Call Translation applications, Text Conversation applications, Calls & Message applications, Bixby Text Call applications, Audio/Video calls applications, Voice Recorder applications. The individual modules can be used for various applications and scenarios. Like ASR modules are being commercialized for Call Translation and Bixby Text Call in S24. In same use cases, the proposed engine can be used for Action generation and for creating Conversation Summary.

Additionally, in an application scenario, a user has hosted a meeting to discuss an event management. The user discusses about several activities with his colleagues, wherein several activities are agreed upon, while a few other activities are disagreed by the team members. Embodiments herein understand the multi-party human conversation, and generate one or more linked actions specific to each user based on the agreement made in the conversation.

According to an embodiment, there is provided a method for recommending at least one user action to be executed in a multi-party conversation, the method including: generating intent information including an intent of at least one of a first participant and a second participant, among a plurality of participants, based on the multi-party conversation; generating at least one first inference for the at least one of the first participant and the second participant based on the intent information; obtaining at least one first action linked to the intent information based on the at least one first inference; and activating an application of an electronic device to perform at least one similar action determined for the at least one of the first participant and the second participant based on at least one agreement between the first participant and the second participant of the multi-party conversation corresponding to the at least one first action linked to the intent information.

According to an embodiment, there is provided a method for generating a plurality of user actions in a multi-party conversation, the method including: generating, by an inference engine of an electronic device, a first inference including an information about a first action to be performed by a first participant in the multi-party conversation, based on the first participant having a conversation with a second participant in the multi-party conversation; generating, by the inference engine of the electronic device, a second inference including an information about a second action to be performed by the second participant based on the second participant having a conversation with a third participant in the multi-party conversation; and generating, by the inference engine of the electronic device, a third inference including an information about a third action to be performed by the first participant, based on the first participant having a conversation with the third participant, wherein the information about the third action to be performed is generated considering the first action and the second action.

According to an embodiment, there is provided an electronic device including: memory storing one or more instructions, and at least one processor configured to execute the one or more instructions to: generate intent information including an intent of at least one of a first participant and a second participant, among the plurality of participants, based on the multi-party conversation; generate at least one first inference for the at least one of the first participant and the second participant based on the intent information; obtain at least one first action linked to the intent information based on the at least one first inference; and activate an application of the electronic device to perform at least one similar action determined for the at least one of the first participant and the second participant based on at least one agreement between the first participant and the second participant of the multi-party conversation corresponding to the at least one first action linked to the intent information.

One or more embodiments of the disclosure may be implemented through at least one software program running on at least one hardware device and performing management functions to manage one or more actions generated from a multi-party conversation. The recommender unit (100) in FIGS. 1A, 1B and 2 include blocks which can be at least one of a hardware device, or a combination of hardware device and software module.

One or more embodiments of the disclosure are directed to method(s) and system(s) for managing one or more user actions to be executed in a multi-party conversation. Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method may be implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method, according to one or more embodiment, may be implemented partly in hardware and partly in software (e.g., combination of hardware and software). According to an embodiment, one or more aspect of the inventive concept may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method for recommending at least one user action to be executed in a multi-party conversation, the method comprising:
generating intent information comprising an intent of at least one of a first participant and a second participant, among a plurality of participants, based on the multi-party conversation;
generating at least one first inference for the at least one of the first participant and the second participant based on the intent information;
obtaining at least one first action linked to the intent information based on the at least one first inference; and
activating an application of an electronic device to perform at least one similar action determined for the at least one of the first participant and the second participant based on at least one agreement between the first participant and the second participant of the multi-party conversation corresponding to the at least one first action linked to the intent information.

2. The method as claimed in claim 1, further comprising: estimating the at least one agreement between the first participant and the second participant from the multi-party conversation.

3. The method as claimed in claim 1, wherein the generating the intent information comprises identifying a plurality of text entities from at least one transcript of the multi-party conversation.

4. The method as claimed in claim 3, wherein the method comprises:
classifying, the intent information, into at least one of, the at least one first action linked to the intent information, at least one query linked to the multi-party conversation, and at least one response linked to the multi-party conversation.

5. The method as claimed in claim 1, further comprising identifying the plurality of participants participating in the multi-party conversation.

6. The method as claimed in claim 1, wherein the generating the at least one first action comprises:
generating at least one second inference, the at least one second inference comprising information of at least one second-action for the at least one of the first participant and the second participant conversing with at least one third participant of the multi-party conversation; and
generating the at least one first action linked to the intent information based on the at least one second inference.

7. The method as claimed in claim 6, wherein the generating the at least one first action comprises:
generating at least one multi-level inference, the at least one multi-level inference comprises information of the at least one first inference and the at least one second inference; and
generating the at least one first action linked to the intent information based on the at least one multi-level inference.

8. The method as claimed in claim 11, wherein the generating the at least one first action comprises:
obtaining past conversation information of at least the first participant, the second participant and the third participant; and
generating the at least one first action based on at least one of a current conversation information from the multi-party conversation and the past conversation information of the first participant, the second participant and the third participant.

9. The method as claimed in claim 1, wherein the at least one similar action is determined based on at least one agreement between at least one of,
the first participant and the third participant conversing with the first participant; and
the second participant and the third participant conversing with the second participant.

10. The method as claimed in preceding claim 9, further comprising determining at least one dependent action for at least one of the first participant, the second participant and the third participant based on the at least one similar action.

11. A method for generating a plurality of user actions in a multi-party conversation, the method comprises:
generating, by an inference engine of an electronic device, a first inference including an information about a first action to be performed by a first participant in the multi-party conversation, based on the first participant having a conversation with a second participant in the multi-party conversation;
generating, by the inference engine of the electronic device, a second inference including an information about a second action to be performed by the second participant based on the second participant having a conversation with a third participant in the multi-party conversation; and
generating, by the inference engine of the electronic device, a third inference including an information about a third action to be performed by the first participant, based on the first participant having a conversation with the third participant, wherein the information about the third action to be performed is generated considering the first action and the second action.

12. The method as claimed in claim 11, wherein generating the third action comprises recognizing commonality between the first action and the second action, and conflicts between the first action and the second action.

13. The method as claimed in claim 11, further comprising:
generating information on the first participant, the second participant and the third participant;
classifying the generated information; and
generating the first action, the second action, and the third action based on the classified generated information.

14. The method as claimed in claim 11, further comprising:
determining, state of an agreement between the first participant, the second participant and the third participant, related to the first action, the second action, and the third action for generating the at least one of the first inference, the second inference and the third inference, corresponding to the at least one the first action, the second action and the third action respectively.

15. An electronic device comprising:
memory storing one or more instructions, and
at least one processor configured to execute the one or more instructions to:
generate intent information comprising an intent of at least one of a first participant and a second participant, among the plurality of participants, based on the multi-party conversation;
generate at least one first inference for the at least one of the first participant and the second participant based on the intent information;
obtain at least one first action linked to the intent information based on the at least one first inference; and
activate an application of the electronic device to perform at least one similar action determined for the at least one of the first participant and the second participant based on at least one agreement between the first participant and the second participant of the multi-party conversation corresponding to the at least one first action linked to the intent information.

16. The electronic device as claimed in claim 15, wherein the at least one processor is further configured to:
estimate the at least one agreement between the first participant and the second participant from the multi-party conversation.

17. The electronic device as claimed in claim 15, wherein the at least one processor is further configured to:
identify a plurality of text entities from at least one transcript of the multi-party conversation.

18. The electronic device as claimed in claim 17, wherein the at least one processor is further configured to:
classify, the intent information, into at least one of, the at least one first action linked to the intent information, at least one query linked to the multi-party conversation, and at least one response linked to the multi-party conversation.

19. The electronic device as claimed in claim 15, further comprising identifying the plurality of participants participating in the multi-party conversation.

20. The electronic device as claimed in claim 15, wherein the at least one processor is further configured to:
generate at least one second inference, the at least one second inference comprising information of at least one second-action for the at least one of the first participant and the second participant conversing with at least one third participant of the multi-party conversation; and
generate the at least one first action linked to the intent information based on the at least one second inference.
